(19) United States
(12) Patent Application Publication
(10) Pub. No.: US 2025/0108529 A1
(43) Pub. Date: Apr. 3, 2025

(54) HAIR CUTTING APPLIANCE AND ASSOCIATED POWER TRANSFORM MODULE

(71) Applicant: The Gillette Company LLC, Boston, MA (US)

(72) Inventors: Aditya Milind Deshpande, Cincinnati, OH (US); Eduardo Romo Escalante, Reading (GB); Faiz Feisal Sherman, Mason, OH (US); Ian Anthony Good, Reading (GB)

(21) Appl. No.: 18/479,340

(22) Filed: Oct. 2, 2023

(51) Int. Cl. B26B 19/38; B26B 19/20; B26B 19/46

(52) U.S. Cl. CPC B26B 19/388; B26B 19/20; B26B 19/3886; B26B 19/46

(57) ABSTRACT

A hair cutting appliance is presented including a body with a power switch and a power source. A drive system within the body is in selective electrical communication with the power source. A cutting unit is coupled to the drive system. An optical sensor is positioned to sense a pre-defined skin-hair edge in an area in front of the cutting unit. A switching element is in electrical communication with a control circuit and switchable between a conducting state to electrically connect the drive system and the power source and a non-conducting state to electrically isolate the drive system from the power source. The switching element is switched to the non-conducting state when a first sensed condition of the optical sensor exceeds a first pre-programed threshold. A power transform module is also provided that includes the optical sensor and is configured to be mounted to the body.

### FIELD

The present disclosure relates generally to hair cutting devices used for achieving and maintaining hair styles. More particularly, the present disclosure relates to a hair cutting device for achieving and maintaining hair styles with a clearly defined skin-hair edge.

### BACKGROUND

People with facial hair routinely visit barbers for styling their facial hair in order to get a fresh look. For example, the barber may style the facial hair into a beard having a clearly defined skin-hair edge. After a few days, the barber-crafted style of the facial hair fades away due to hair regrowth. The hair starts to regrow after the barber styling and thus the clearly defined skin-hair edge between the skin and the hair starts to disappear after two or three days.

People desire to maintain their facial hair styles for an extended time once they get their facial hair styled by a barber. However, conventional hair trimming devices in the market do not assist users to easily maintain their facial hair style with the clearly defined skin-hair edge. Instead, a person requires ad hoc tools like beard stencils over the face while shaving to maintain facial hair styles by themselves. Alternatively, a person may utilize a manual razor in a rough attempt to reproduce the facial hair style with the clearly defined skin-hair edge but this is prone to inevitable error. Consequently, people typically must go back to the barber frequently to maintain their facial hair styles, thereby costing them valuable time and money.

Although, there are previously known methods for facial hair style maintenance, they have notable drawbacks. For example, some conventional methods include a shaping tool, such as U.S. Patent Application Publication No. 2016/0255938A1 to Brunett that discloses a facial hair styling tool to assist in grooming, styling, and shaping a man's beard, goatee, mustache, or sideburns while shaving. To style and form the beard, the user places the tool against the side of their face and uses the edges to shave over with a razor. In another example, other conventional methods include using a chemical marker to define the skin-hair edge in addition to a cutting instrument for cutting the hair and/or stubble, such as disclosed in U.S. Pat. No. 10,131,061B2 to Krans et al. However, the use of these conventional methods to maintain a facial hair style with a skin-hair edge makes the process of self-style maintenance cumbersome.

The discussion of shortcomings and needs existing in the field prior to the present disclosure is in no way an admission that such shortcomings and needs were recognized by those skilled in the art prior to the present disclosure.

### SUMMARY

Various embodiments provide methods and devices useful for solving the style maintenance problem for facial hair discussed above. The advantage achieved by these methods and devices is quicker and easier self-maintenance of facial hair styles with a clearly defined skin-hair edge, leading to a reduced frequency of barber visits.

In a first set of embodiments, a hair cutting appliance is presented. The hair cutting appliance includes a body having a consumer actuated power switch and a power source in electrical communication with the power switch. The hair cutting appliance also includes a drive system positioned within the body in selective electrical communication with the power source and a cutting unit coupled to the drive system and including an external cutting member. The hair cutting appliance also includes an optical sensor mounted to the body and positioned to sense a pre-defined skin-hair edge in an area in front of the external cutting member. The hair cutting appliance also includes a control circuit positioned within the body and in electrical communication with the optical sensor. The hair cutting appliance also includes a switching element in electrical communication with the control circuit. The switching element is switchable by the control circuit between a conducting state to electrically connect the drive system and the power source and a non-conducting state to electrically isolate the drive system from the power source. The switching element is switched by the control circuit to the non-conducting state when a first sensed condition of the optical sensor exceeds a first pre-programed threshold stored by the control circuit.

In a second set of embodiments, a power transform module for use with a hair cutting appliance is provided. The hair cutting appliance includes a body having a consumer actuated power switch, a power source in electrical communication with the power switch, a drive system positioned within the body in selective electrical communication with the power source and a cutting unit coupled to the drive system and including an external cutting member. The hair cutting appliance also includes a control circuit positioned within the body and a switching element in electrical communication with the control circuit. The switching element is switchable by the control circuit between a conducting state to electrically connect the drive system and the power source and a non-conducting state to electrically isolate the drive system from the power source. The power transform module includes an optical sensor and an optical source. The power transform module is configured to be mounted to the body of the hair cutting appliance such that upon mounting the power transform module to the body: the optical sensor and the optical source are in communication with the power source; the optical sensor is in electrical communication with the control circuit; the optical source is configured to project an optical signal at an area in front of the external cutting member; the optical sensor is configured to sense a pre-defined skin-hair edge in the area in front of the external cutting member; and the switching element is configured to be switched by the control circuit to the non-conducting state when a first sensed condition of the optical sensor exceeds a first-preprogrammed threshold stored by the control circuit.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIGS. 1A and 1B is an example according to various embodiments illustrating facial hair on a face of a user before and after visiting a barber;

FIGS. 1C and 1D is an example according to various embodiments illustrating facial hair on a face of a user before and after using the hair cutting appliance;

FIG. 2A is an example according to various embodiments illustrating a block diagram of a hair cutting appliance in a non-conducting state;

FIG. 2B is an example according to various embodiments illustrating a block diagram of the hair cutting appliance of FIG. 2A in a conducting state;

FIGS. 3A through 3E is an example according to various embodiments illustrating various views of a hair cutting appliance;

FIGS. 4A through 4C is an example according to various embodiments illustrating a hair cutting appliance being moved across a skin surface;

FIG. 5A is an example according to various embodiments illustrating facial hair on a face of a user during use of the hair cutting appliance;

FIGS. 5B and 5C is an example according to various embodiments illustrating a side view of a hair cutting appliance being used to cut hair adjacent to a skin-hair edge of a facial hair design;

FIGS. 6A and 6B is an example according to various embodiments illustrating block diagrams of a power transform module used with a hair cutting appliance;

FIG. 6C is an example according to various embodiments illustrating a side view of the power transform module of FIGS. 6A and 6B mounted to a hair cutting appliance; and

FIG. 7 is an example according to various embodiments illustrating a flowchart that depicts a method for assembling a hair cutting appliance;

FIG. 8 is an example according to various embodiments illustrating a block diagram of a computer system upon which an embodiment of the invention may be implemented; and

FIG. 9 is an example according to various embodiments illustrating a chip set upon which an embodiment of the invention may be implemented;

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Hair style” generally refers to a region of hair on a skin surface with one or more desired characteristics such as area, hair length, hair density, shape, skin-hair edge, etc.

“Skin-hair edge” generally refers to a desired characteristic of a hair style including a pre-defined or desired edge of the hair style that indicates a boundary between skin outside the hair style and hair within the hair style.

### Pre-Defined Skin-Hair Edge

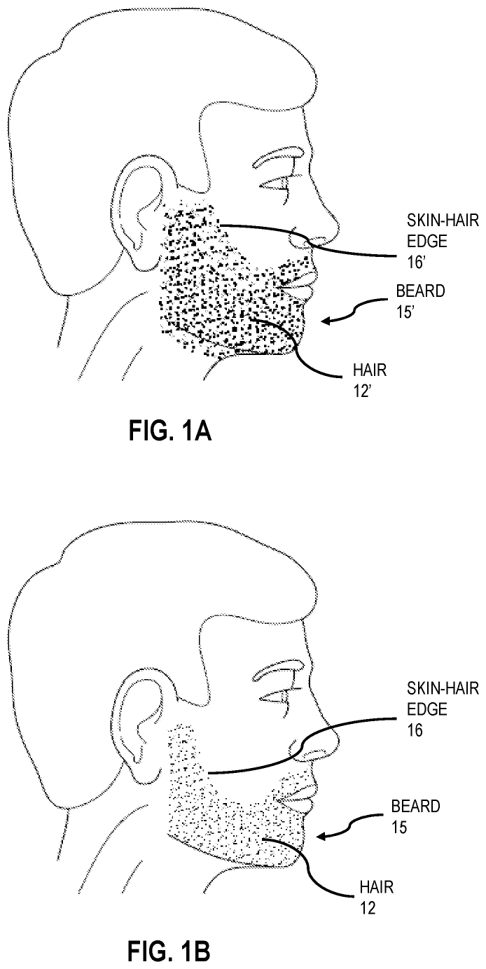

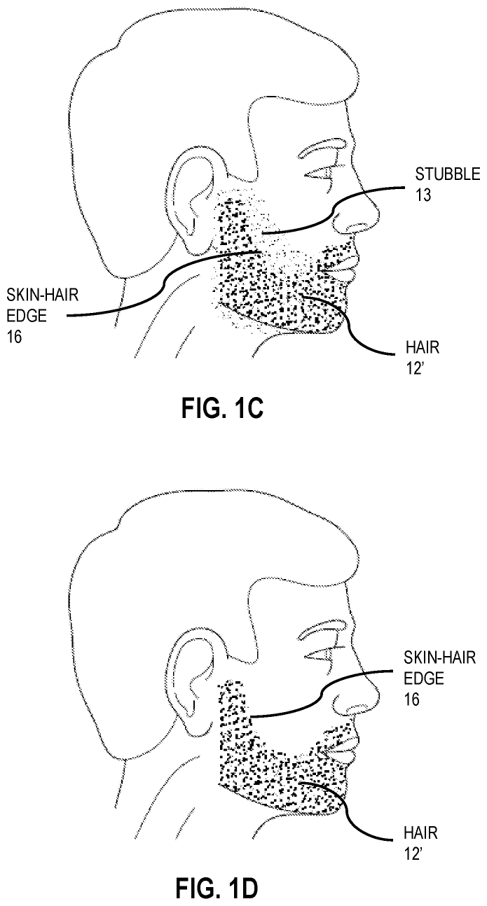

FIGS. 1A and 1B is an example according to various embodiments illustrating facial hair on a face of a user before and after visiting a barber. In an embodiment, FIG. 1A depicts a facial hair style or beard 15′ on the face of the user that is based on natural facial hair growth of the user. The beard 15′ features a skin-hair edge 16′ between the hair 12′ of the beard 15′ and the facial skin. The skin-hair edge 16′ is based on the natural facial hair growth of the user and thus has not been shaped with a hair trimming device. The hair 12′ within the beard 15′ has also not been trimmed by a hair trimming device.

FIG. 1B depicts the user after visiting a barber where the barber adjusts one or more parameters of the beard 15′ of FIG. 1A (e.g. length of the hair, shape of the skin-hair edge). As shown in FIG. 1B, the facial hair style or beard 15 features a skin-hair edge 16 which is different from the skin-hair edge 16′ of FIGS. 1A and 1s shaped to achieve one or more desired characteristics of the beard 15 (e.g. shape, coverage area, etc.). The hair 12 of the beard 15 has also been trimmed from the length of the hair 12′ of the beard 15′ in FIG. 1A to a desired length. Consequently, the beard 15 depicted in FIG. 1B features one or more desired characteristics (e.g. length of the hair 12, shape of the skin-hair edge 16, etc.).

FIG. 1C depicts the user shown in FIG. 1B after several days (e.g. 2 to 7 days). As shown in FIG. 1C, hair has regrown outside of the skin-hair edge 16 and is depicted as stubble 13 in FIG. 1C. For purposes of this description, “stubble” refers to hair that has a length consistent with a natural growth rate of hair over a certain time period, such as between 1 days and 7 days. Additionally, as shown in FIG. 1C the hair 12 of FIG. 1B that was within the skin-hair edge 16 has now grown into hair 12′ having a longer length than the hair 12 in FIG. 1B.

The hair cutting appliance disclosed herein is advantageously employed by a user to replicate the one or more desired characteristics of the beard 15 depicted in FIG. 1B. FIG. 1D depicts the user shown in FIG. 1C after using the hair cutting appliance disclosed herein. As shown in FIG. 1D, based on using the hair cutting appliance disclosed herein, the stubble 13 of FIG. 1C that is outside the skin-hair edge 16 has been cut whereas the hair 12′ within the skin-hair edge 16 has not been cut. Consequently, the desired skin-hair edge 16 is maintained by using the hair cutting appliance. The embodiments disclosed herein explain how the hair cutting appliance selectively cuts hair (e.g. stubble 13) outside the skin-hair edge 16 while not cutting hair within the skin-hair edge 16. As further shown in FIG. 1D, the hair 12′ within the skin-hair edge 16 is longer than the hair 12 within the skin-hair edge 16 of FIG. 1B and thus in some embodiments the hair cutting appliance can be used (in a manual operating mode) to trim the length of the hair 12′ back to the desired length of the hair 12 depicted in FIG. 1B. As appreciated by one of ordinary skill in the art, this is achieved by using one of several depth guides that trim the length of the hair 12 to a desired length (e.g. ⅛ inch, ¼ inch, etc.).

### Hair Cutting Appliance

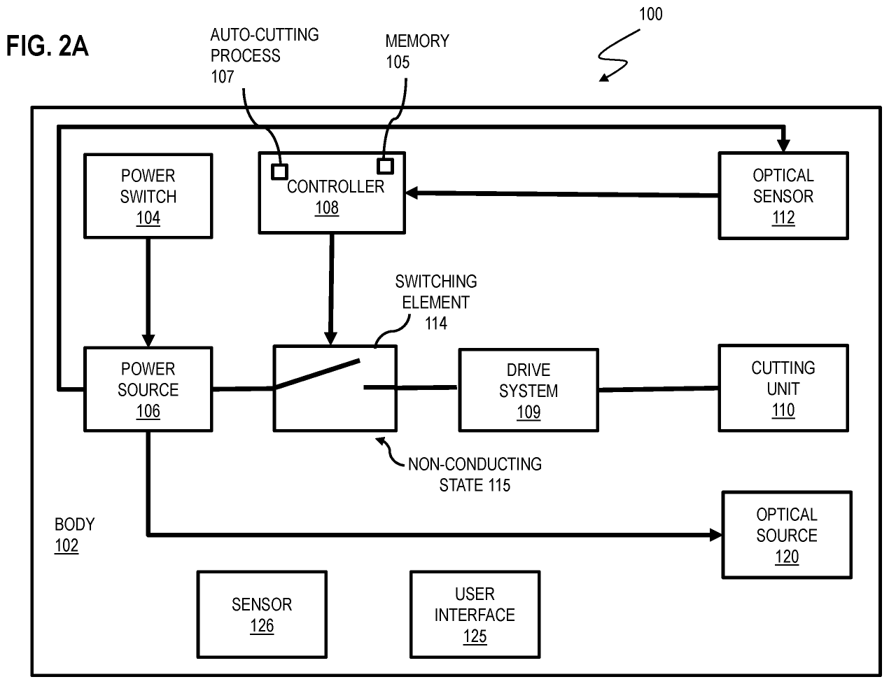

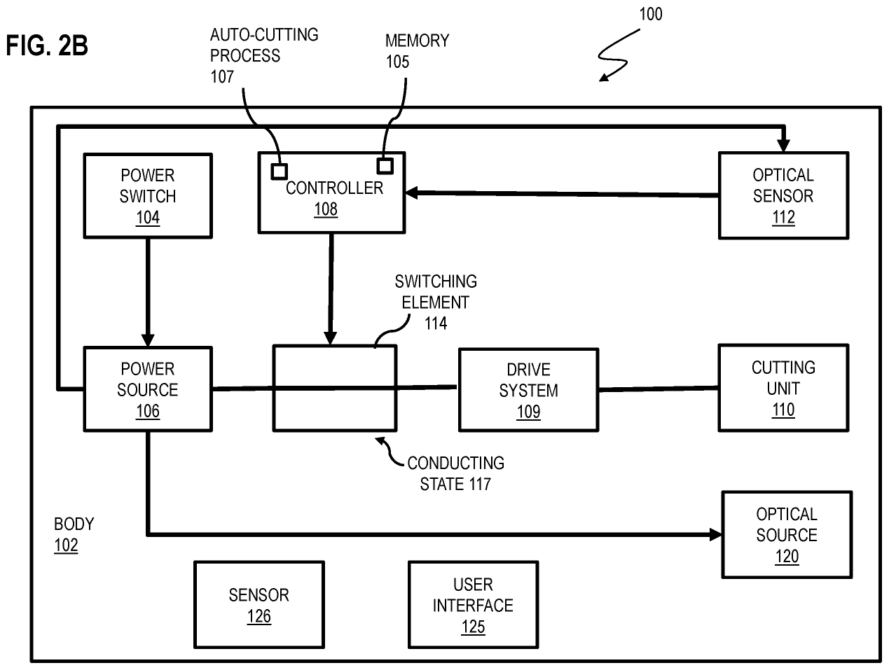

An embodiment of a hair cutting appliance will now be discussed. In this embodiment, the hair cutting appliance is switchable from a non-conducting state, where power is not supplied to a cutting unit of the hair cutting appliance and a conducting state, where power is supplied to the cutting unit. As further discussed herein, the hair cutting appliance is switched to the non-conducting state to stop cutting hair (e.g. hair 12′ within the skin-hair edge 16 of FIG. 1C) and is switched to the conducting state to cut hair (e.g. stubble 13 outside the skin-hair edge 16 of FIG. 1C). The hair cutting appliance will be discussed in the non-conducting state (FIG. 2A) and in the conducting state (FIG. 2B).

FIG. 2A is an example according to various embodiments illustrating a block diagram of a hair cutting appliance 100 in a non-conducting state 115. As shown in FIG. 2A, in one embodiment the hair cutting appliance 100 includes a body 102 having a consumer actuated power switch 104 (e.g., a push button actuator, a motion sensor or a touch sensor). Additionally, the hair cutting appliance includes a power source 106 in electrical communication with the power switch 104. As further shown in FIG. 2A, the hair cutting appliance 100 includes a drive system 109 positioned within the body 102 and in selective electrical communication with the power source 106.

As further shown in FIG. 2A, in an embodiment the hair cutting appliance 100 includes one or more cutting units 110 coupled to the drive system 109 and comprising an external cutting member (e.g., reciprocating blades, rotating blades or linear blades).

Additionally, in an embodiment the hair cutting appliance 100 includes one or more optical sensors 112 mounted to the body 102. As discussed in more detail herein, the optical sensor 112 is positioned to sense the pre-defined skin-hair edge 16 (FIG. 1C) in an area in front of the external cutting member.

As further shown in FIG. 2A, in an embodiment the hair cutting appliance 100 includes a light source or optical source 120 mounted to the body 102. In an embodiment, the optical source 120 is positioned to transmit an optical signal to illuminate the area in front of the external cutting member. As the optical signal from the optical source 120 illuminates the area, the optical sensor 112 captures image data of the area which is then processed by the controller 108 to determine a value of a parameter of hair within the area (e.g. length of hair). The controller 108 then compares this parameter value with a first pre-programmed threshold in order to decide whether to switch the switching element 114 to the non-conducting state 115 (to not cut hair in the area) or the conducting state 117 (to cut hair in the area).

As further shown in FIG. 2A, in an embodiment the hair cutting appliance 100 includes a control circuit or controller 108 positioned within the body 102 and in electrical communication with the optical sensor 112. The controller 108 includes a memory 105 in which one or more pre-programmed thresholds are stored which are used to determine whether or not to cut hair in the area in front of the external cutting member.

In one embodiment, a first pre-programmed threshold is stored in the memory 105, where the first pre-programmed threshold is a threshold value of a parameter of hair that is used to determine whether or not to cut the hair. In one embodiment, the first pre-programmed threshold is one or more of hair length, hair density, hair color, individual hair thickness and hair straightness. In an example embodiment, the first pre-programmed threshold is a hair length threshold (e.g. within a range from about 0.3 mm to about 3.5 mm). In this embodiment, the hair length threshold is based on an average growth rate of human hair (e.g. between about 0.3 mm and about 0.5 mm per day) and a predetermined amount of time (e.g. about 168 hours or in a range from about 120 hours to about 216 hours). In these embodiments, the hair length threshold is used to decide whether or not to cut hair in the area in front of the external cutting member. For example, the hair 12′ of FIG. 1C whose length is above the hair length threshold is recognized as within the pre-defined skin-hair edge 16 of the facial hair style (e.g. beard 15) whereas the hair (e.g. stubble 13 of FIG. 1C) whose length is less than or equal to the hair length threshold is recognized as outside the pre-defined skin-hair edge 16 of the facial hair style (e.g. beard 15). Thus, by not cutting hair 12′ within the pre-defined skin-hair edge 16 and cutting hair (e.g. stubble 13) outside the pre-defined skin-hair edge 16, the pre-defined skin-hair edge 16 is maintained.

The switching element 114 is switched by the controller 108 to the non-conducting state 115 when a first sensed condition of the optical sensor 112 exceeds the first pre-programed threshold stored in the memory 105 of the controller 108. In an example embodiment, the first pre-programmed threshold is the threshold hair length and the first sensed condition indicates that hair in the area has a length greater than the threshold hair length. Consequently, the switching element 114 is switched by the controller 108 to the non-conducting state 115 when the length of hair 12′ (FIG. 1C) in the area exceeds the threshold hair length so that hair 12′ in the area is not cut by the external cutting member (e.g. since the hair 12′ is within the predefined skin-hair edge 16)

Similarly, the switching element 114 is switched by the controller 108 to the conducting state 117 when a second sensed condition of the optical sensor 112 is equal to or less than the first pre-programed threshold stored in the memory 105 of the controller 108. Thus, in an example embodiment, the first pre-programmed threshold is the threshold hair length and the second sensed condition indicates that hair in the area has a length less than or equal to the threshold hair length. Consequently, the switching element 114 is switched by the controller 108 to the conducting state 117 when the length of hair (e.g. stubble 13 of FIG. 1C) in the area is less than or equal to the threshold hair length so that hair (e.g. stubble 13) in the area is cut by the external cutting member (e.g. since the stubble 13 is recognized as outside the predefined skin-hair edge 16).

In one embodiment, a second optional pre-programmed threshold is stored in the memory 105. In one example embodiment, the second pre-programmed threshold is a threshold value of time that is used to determine whether or not to cut the hair. In an example embodiment, the second pre-programmed threshold is a threshold value of elapsed time (e.g., about 168 hours or in a range from about 120 hours to about 216 hours). In this example embodiment, the controller 108 includes a timer (not shown) that measures an elapsed time since a most recent use of the hair cutting appliance 100 (e.g. since a most recent trimming of the beard 15 with the pre-defined skin-hair edge 16). The controller 108 compares the elapsed time (from the timer) with the threshold value of elapsed time and will only switch the switching element 114 to the conducting state 117 if the elapsed time is less than the threshold value of elapsed time. In this example embodiment, the elapsed time being less than the threshold value of elapsed time is a precondition for the controller 108 switching to the switching element 114 to the conducting state 117 (e.g. using the first pre-programmed threshold). In this example embodiment, the second pre-programmed threshold is provided, since if the elapsed time exceeds this threshold, the hair outside the pre-defined skin-hair edge 16 has grown too much so that it cannot be distinguished from the hair within the pre-defined skin-hair edge 16 (e.g. using the first pre-programmed threshold). Consequently, the comparison of the elapsed time with the second pre-programmed threshold advantageously ensures that too much time has not elapsed since the most recent cut of hair outside the pre-defined skin-hair edge 16. However, the second optional pre-programmed threshold is not limited to a time threshold and in other embodiments the second optional pre-programmed threshold can be any parameter value that pertains to the operation of the hair cutting appliance including but not limited to any parameter value of the first pre-programmed threshold. In still other embodiments, the second optional pre-programmed threshold is not utilized and instead the first pre-programmed threshold is considered during the operation of the hair cutting appliance 100.

In an embodiment, the hair cutting appliance 100 includes a sensor 126 configured to determine that the external cutting member is in contact with a skin surface. In an example embodiment, the sensor 126 is one of a time-of-flight sensor, a capacitive touch sensor or a sensor configured to detect movement of a wheel encoder on the surface.

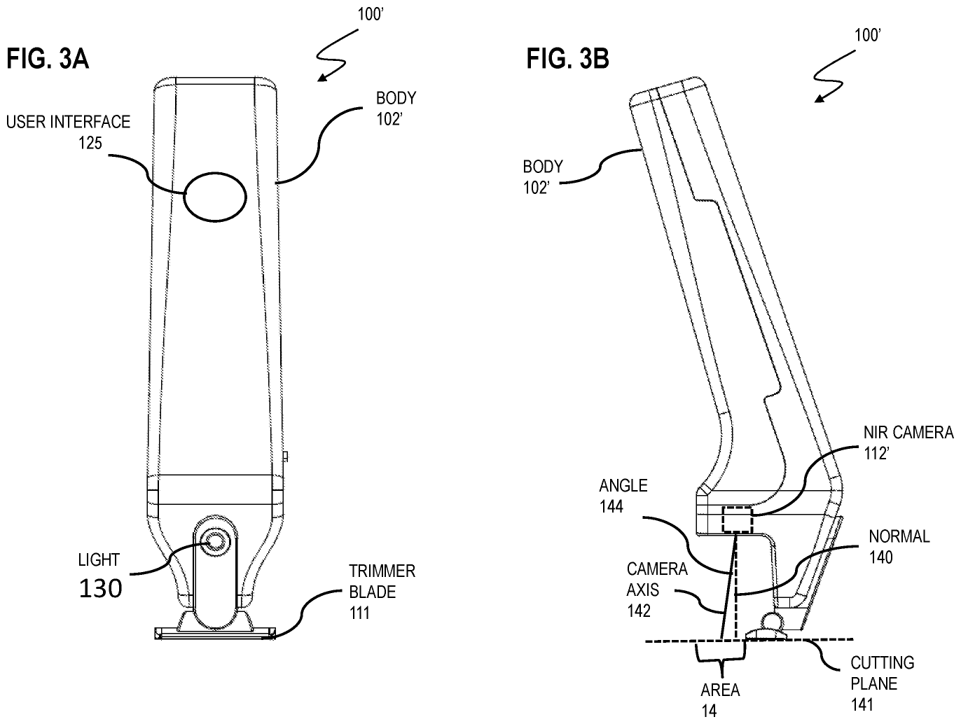

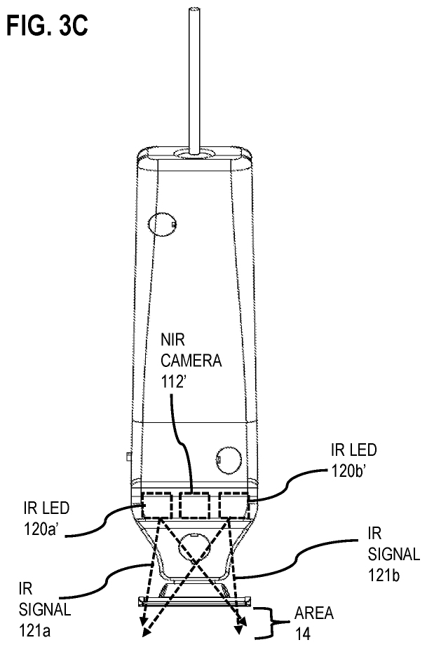

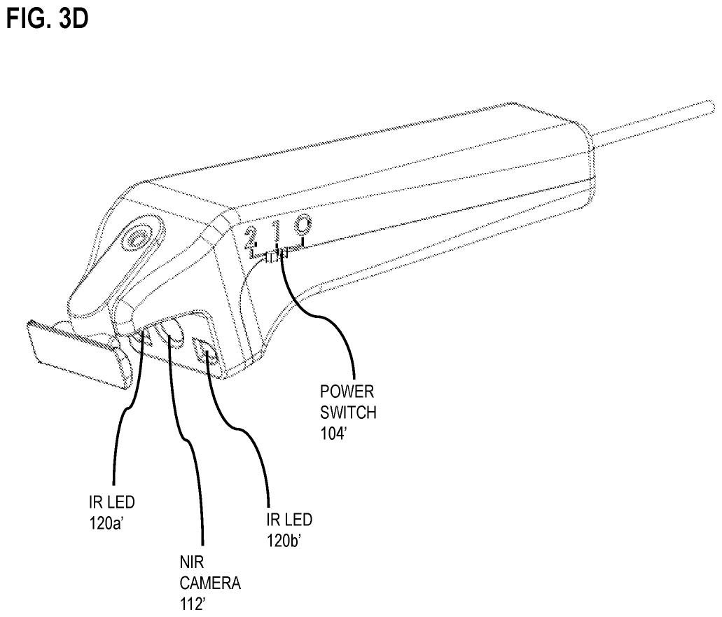

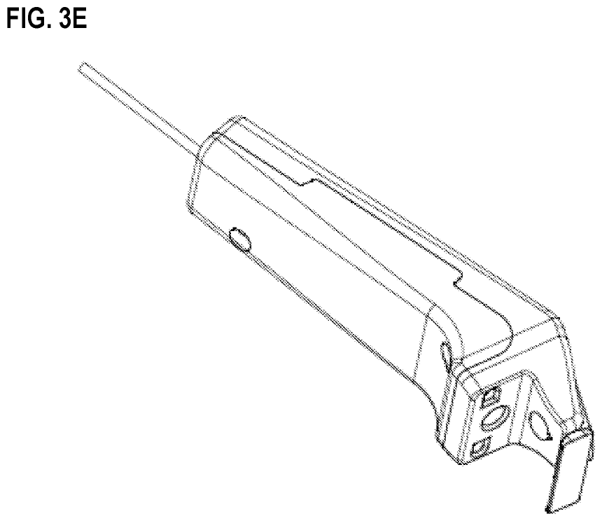

One particular embodiment of the hair cutting appliance 100′ will now be discussed. FIGS. 3A through 3E is an example according to various embodiments illustrating different views of the hair cutting appliance 100′. As shown in FIG. 3A, in an embodiment a user interface 125 is provided on the body 102′. In one embodiment, the user interface 125 indicates a status of the switching element 114 (e.g., conducting state 117 or non-conducting state 115). In other embodiments, the controller 108 sends a signal to the user interface 125 on the body 102′ to indicate a stroke speed of the hair cutting appliance 100′ over the skin surface. In an example embodiment, the controller 108 sends a signal to the user interface 125 to provide feedback to the user regarding the stroke speed (e.g. to indicate that the stroke speed is too high if the user is moving the hair cutting appliance over the skin surface too quickly). In another example embodiment, image data captured by the NIR camera 112′ is processed by the controller 108 to determine the stroke speed.

In another embodiment, the user interface 125 is provided to output data pertaining to the use of the hair cutting appliance 100′. In one example embodiment, the user interface 125 is in communication with the controller 108. Upon the controller 108 receiving a first signal from the timer indicating an elapsed time since a most recent use of the hair cutting appliance 100′, the controller 108 transmits a second signal to the user interface 125 to output one or more of the elapsed time and/or a time frequency of use of the hair cutting appliance 100′ over a predetermined time period (e.g. how many times the hair cutting appliance has been used in the past month).

As shown in FIG. 3A, in an embodiment a light 130 is provided on the body 102′. In one example embodiment, the light 130 is configured to output one or more characteristics (e.g. color, flashing or not flashing, etc.) depending on the operational mode of the hair cutting appliance 100′ (e.g. based on the position of the power switch 104′).

As shown in FIGS. 3B and 3C, in one embodiment the optical sensor is a camera 112′, such as an infrared (IR) camera or near infrared (NIR) camera. In one embodiment the optical source is an IR source, such as an IR light emitting diode (LED) 120′. In one example embodiment, a wavelength of the optical source is in a range from about 400 nm to about 700 nm. In another example embodiment, the wavelength of the optical source is in a range from about 700 to about 1000 nm. In yet another example embodiment, the wavelength of the optical source is in a range from about 400 nm to about 1000 nm.

In one embodiment the optical source is a plurality of optical sources that are arranged around the optical sensor. As shown in FIGS. 3C and 3D, a plurality of IR LEDs 120a′, 120b′ are arranged around the NIR camera 112′. As shown in FIG. 3A, in one embodiment the external cutting member is a trimmer blade 111 and the plurality of IR LEDs 120a′, 120b′ direct an IR signal 121a, 121b at an area 14 in front of the trimmer blade 111 to illuminate the area 14.

As shown in FIG. 3B, in one embodiment the NIR camera 112′ is mounted to the body 102′ such that an optical axis 142 of the NIR camera 112′ is oriented at an angle 144 relative to a normal direction 140 to a cutting plane 141 defined by the trimmer blade 111. In an embodiment, the cutting plane 141 is defined as a plane that is tangential or parallel to a base of the trimmer blade 111 that contacts the skin surface during use of the hair cutting appliance 100′. In an example embodiment, the angle 144 is in a range between about 0 degrees and about 60 degrees. As shown in FIG. 3B, in an embodiment the angle 144 is measured relative to the normal direction 140 in a direction away from the trimmer blade 111. In one embodiment, the NIR camera 112′ has a fixed focal length which is based on the cutting plane 141 (e.g. so that the NIR camera 112′ is focused on the skin surface traversed by the base of the trimmer blade 111).

As shown in FIG. 3D, in one embodiment the power switch 104′ provided on the body 102′ can be used to select between one or more operational modes of the hair cutting appliance 100′. A first operational mode is selected using one position (“1” in FIG. 3D) of the power switch 104′. The first operational mode is a mode in which the hair cutting appliance 100′ is used to maintain the pre-defined hair-skin edge 16 and thus the controller 108 switches the switching element 114 between the conducting state 117 or non-conducting state 115. A second operational mode is selected using another position (“2” in FIG. 3D) of the power switch 104′. The second operation mode is a mode where the hair cutting appliance 100′ remains in the conducting state 117. In one embodiment, the second operational mode is employed when a user wants to use the hair cutting appliance 100′ as a conventional hair cutting appliance. In one example embodiment, after using the hair cutting appliance 100′ in the first operational mode to maintain the pre-defined skin-hair edge 16 (FIG. 1D), the second operational mode can be employed (e.g. with one or more depth guides) to trim the length of hair 12′ within the pre-defined skin-hair edge 16 to a desired length (e.g. to the length of hair 12 shown in the beard 15 of FIG. 1B). The power switch 104′ also includes an off position (“0” in FIG. 3D) such that the hair cutting appliance 100′ remains in the non-conducting state 115.

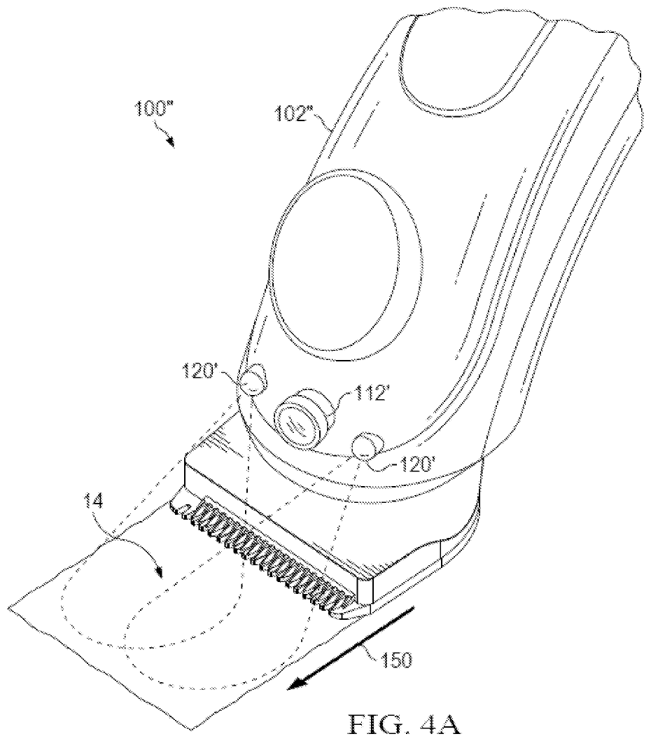

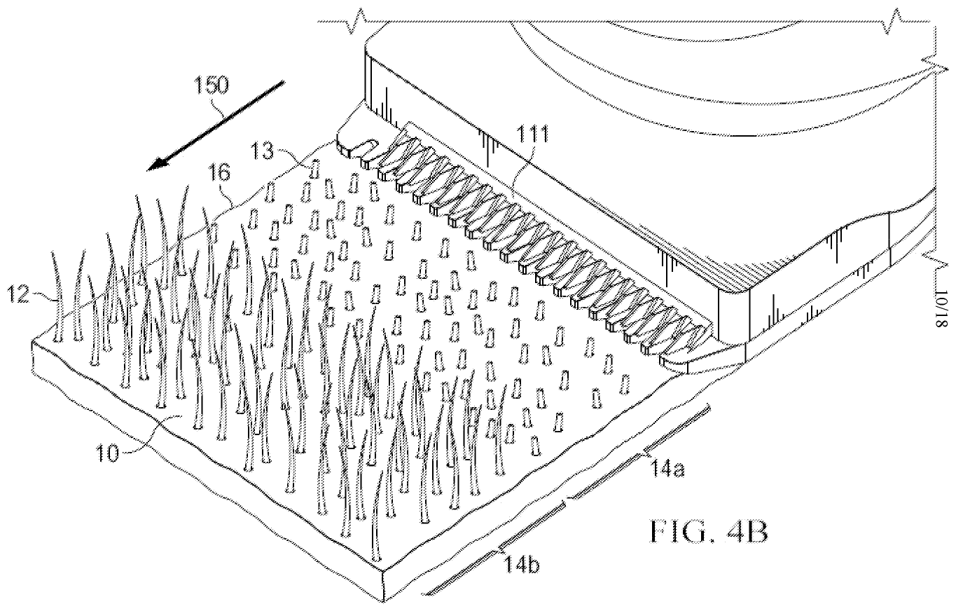

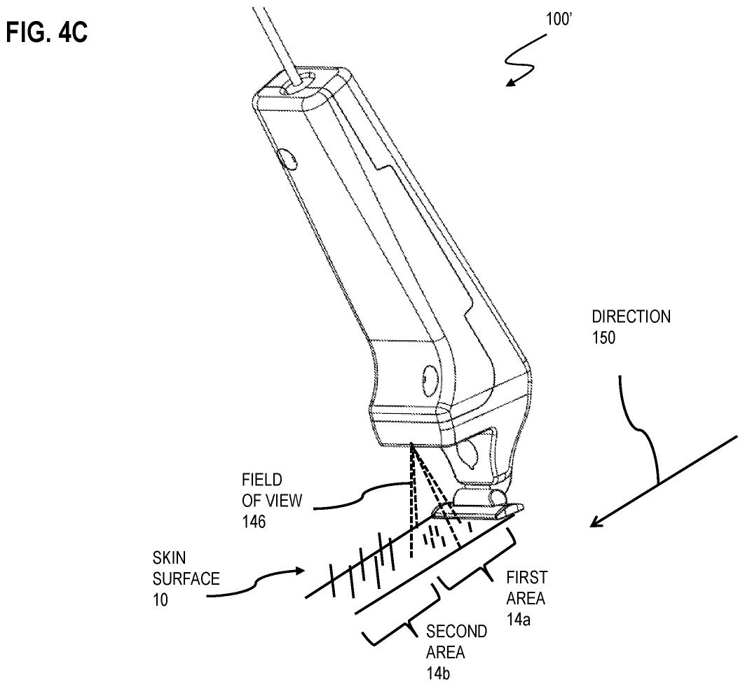

The operation of the hair cutting appliance will now be discussed as it is moved over a skin surface. FIGS. 4A through 4C is an example according to various embodiments illustrating a hair cutting appliance 100′, 100″ being moved across a skin surface 10. It should be noted that the hair cutting appliance 100″ of FIGS. 4A and 4B differs from the hair cutting appliance 100′ of FIGS. 3A through 3E. In one embodiment, the body 102″ of the hair cutting appliance 100″ is shaped differently than the body 102′ of the hair cutting appliance 100′. As with the hair cutting appliance 100′ of FIGS. 3A through 3E, the IR LEDs 120′ and the NIR camera 112′ are mounted to the body 102″ so to respectively illuminate and capture image data from the area 14 in front of the trimmer blade 111.

FIG. 4B depicts the hair cutting appliance 100″ being moved in a direction 150 over the skin surface 10. FIG. 4C similarly depicts the hair cutting appliance 100′ (FIGS. 3A through 3E) being moved in the direction 150 over skin surface 10. A first area 14a of the skin surface 10 features stubble 13 (e.g. hair having a length that is less than or equal to the first pre-programmed threshold) and a second area 14b of the skin surface 10 features hair 12 (e.g. hair having a length greater than the first pre-programmed threshold). The pre-defined skin hair edge 16 is depicted between the first area 14a and second area 14b. Consequently, the stubble 13 in the first area 14a is indicative of hair that has regrown beyond the predefined skin-hair edge 16 (e.g. a few days after a most recent use of the hair cutting appliance or a barber visit). Accordingly, the hair cutting appliance 100′, 100″ is used to cut the stubble 13 in the first area 14a and to not cut the hair 12 in the second area 14b and thus maintain the pre-defined skin-hair edge 16.

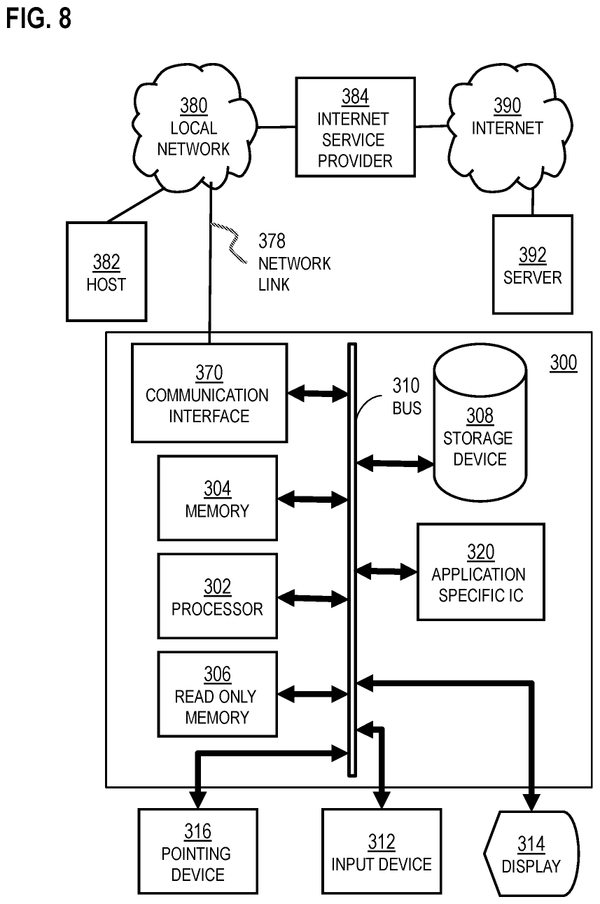

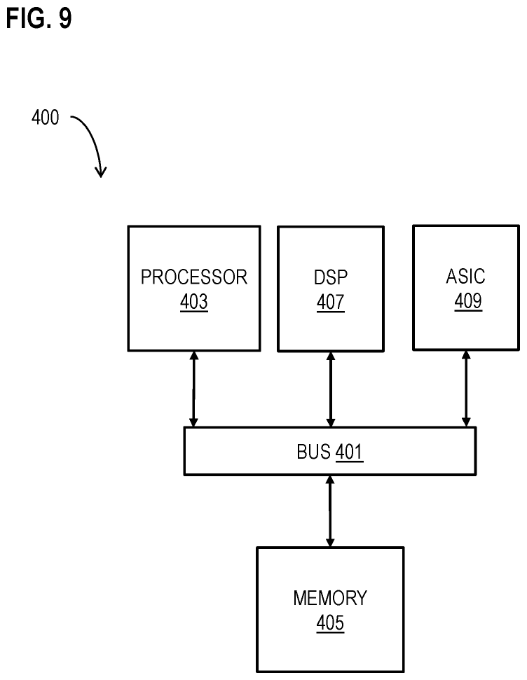

The operation of the hair cutting appliance 100′, 100″ is now discussed in terms of the steps taken in cutting the stubble 13 in the first area 14a and not cutting the hair 12 in the second area 14b. In various embodiments, the controller 108 includes an auto-cutting process module 107 that includes instructions to cause the controller 108 to perform one or more steps discussed herein. In various embodiments, the controller 108 is a general purpose computer system, as depicted in FIG. 8 or one or more chip sets as depicted in FIG. 9.

The following steps are performed by the controller 108 when the instructions of the auto-cutting process module 107 are executed. As the hair cutting appliance 100′, 100″ moves over the skin surface 10, the IR LEDs 120′ illuminate the first area 14a with the IR signal 121a, 121b and the NIR camera 112′ captures first image data of the first area 14a. As shown in FIG. 4C, the IR signals 121a, 121b span a field of view 146 that encompasses the first area 14a. This first image data is transmitted from the NIR camera 112′ to the controller 108. The controller 108 then determines a value of a parameter of hair (e.g. length of the stubble 13) in the first area 14a based on the first image data. This step involves image processing of the first image data, as appreciated by one of ordinary skill in the art. McMullen, Roger L. “Image analysis tools to quantify visual properties of hair fiber assemblies.” Practical Modern Hair Science; Evans, T., Wickett, R R, Eds (2012): 295-332. The controller 108 then compares the determined parameter value of the hair (e.g., length of the stubble 13) in the first area 14a with the first pre-programmed threshold (e.g. hair length threshold) stored in the memory 105. Upon determining that the parameter value of the hair (e.g. length of the stubble 13) is less than or equal to the first pre-programmed threshold (e.g. hair length threshold), the controller 108 transmits a signal to switch the switching element 114 to the conducting state 117. Consequently, the stubble 13 in the first area 14a is cut by the trimmer blade 111.

As the hair cutting appliance 100′, 100″ continues to move in the direction 150 over the skin surface 10 and to the second area 14b, the IR LEDs 120′ illuminate the second area 14b with the IR signal 121a, 121b and the NIR camera 112′ captures second image data of the second area 14b. This second image data is transmitted from the NIR camera 112′ to the controller 108. The controller 108 then determines a value of a parameter of hair (e.g. length of the hair 12) in the second area 14b based on the second image data. The controller 108 then compares the parameter value of the hair (e.g., length of the hair 12) in the second area 14b with the first pre-programmed threshold (e.g. hair length threshold) stored in the memory 105. Upon determining the parameter value of the hair (e.g. length of the hair 12) exceeds the first pre-programmed threshold (e.g. hair length threshold), the controller 108 transmits a signal to switch the switching element 114 to the non-conducting state 115. Consequently, the hair 12 in the second area 14b is not cut by the trimmer blade 111.

In some embodiments, the hair cutting appliance features a calibration mode in which the value of the first pre-programmed threshold is determined and stored in the memory 105 of the controller 108. In an embodiment, after having the beard 15 trimmed by the barber (FIG. 1B) with the one or more desired characteristics (e.g., pre-defined skin-hair edge 16, hair 12 with desired length, etc.), the hair cutting appliance can be switched into the calibration mode. In one example embodiment, the power switch 104′ of FIG. 3D can include an additional position to select the calibration mode. After switching the hair cutting appliance into the calibration mode, the hair cutting appliance is moved over the hair 12 within the pre-defined skin-hair edge 16 of FIG. 1B. Image data of the hair 12 within the pre-defined skin-hair edge 16 is captured by the optical sensor 112 and transmitted to the controller 108. The controller 108 then processes the image data to determine a value of a parameter (e.g. length) of the hair 12 within the pre-defined skin-hair edge 16. The controller 108 then stores a value of the first-preprogrammed threshold in the memory 105, based on this determined parameter value (e.g. length) of the hair 12 within the pre-defined skin-hair edge 16. In one example embodiment, the stored value of the first pre-programmed threshold is the determined parameter value (e.g. length). In another example embodiment, the stored value of the first pre-programmed threshold is a ratio of the determined parameter value, where the ratio is less than 1. This advantageously ensures that hair having the same or greater length as the hair 12 within the pre-defined skin-hair edge 16 is not cut by the hair cutting appliance whereas hair with a length less than the hair 12 within the pre-defined skin-hair edge 16 (e.g. stubble 13) is cut by the hair cutting appliance.

However, the value of the first pre-programmed threshold need not be determined with the calibration mode. In a different embodiment, a user can input a value of the first pre-programmed threshold using an input device (e.g. input device 312) and this inputted value is stored in the memory 105 of the controller 108. In yet another embodiment, the hair cutting appliance is provided with the value of the first pre-programmed threshold pre-stored in the memory 105.

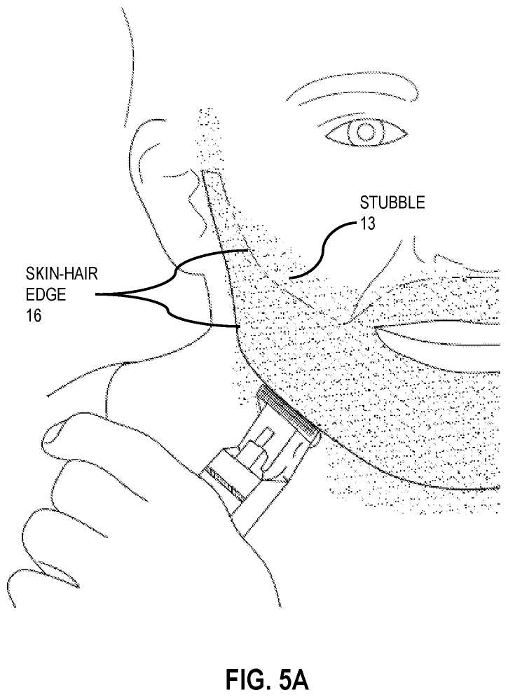

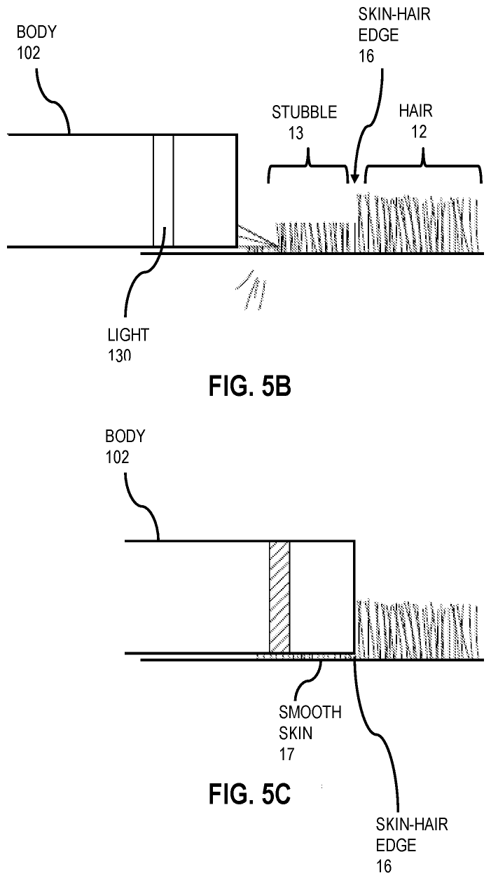

FIG. 5A is an example according to various embodiments illustrating facial hair on a face of a user during use of the hair cutting appliance. In an embodiment, FIG. 5A depicts a user that is similar to the user depicted in FIG. 1C, where stubble 13 has grown beyond the pre-defined hair-skin edge 16. FIG. 5A further depicts the user employing the hair cutting appliance disclosed herein to maintain the pre-defined skin-hair edge 16.

FIG. 5B depicts the body 102 of the hair cutting appliance 100 being moved over the skin surface 10. As the body 102 approaches the stubble 13 in the first area 14a, the controller 108 determines that the hair parameter value (e.g. length of the stubble 13) in the first area 14a is less than or equal to the first pre-determined threshold (e.g. threshold length value). Consequently, the controller 108 transmits a signal to switch the switching element 114 to the conducting state 117 in order to cut the stubble 13 in the first area 14b. As further shown in FIG. 5B, the light 130 on the body 102 indicates that the switching element 114 is in the conducting state 117 (e.g. outputs a first color, such as green).

FIG. 5C depicts the body 102 of the hair cutting appliance 100 being moved over the skin surface 10. As the body 102 approaches the hair 12 in the second area 14b, the controller 108 determines that the hair parameter value (e.g. length of the hair 12) in the second area 14b exceeds the first pre-determined threshold (e.g. threshold length value). Consequently, the controller 108 transmits a signal to switch the switching element 114 to the non-conducting state 115 in order to not cut the hair 12 in the second area 14b. As a result of the use of the hair cutting appliance 100. the pre-defined skin-hair edge 16 is maintained since the stubble 13 outside the pre-defined skin-hair edge 16 is cut whereas the hair 12 within the pre-defined skin-hair edge 16 is not cut. As further shown in FIG. 5C, the light 130 on the body 102 indicates that the switching element 114 is in the non-conducting state 115 (e.g. outputs a second color different than the first color, such as red).

### Power Transform Module

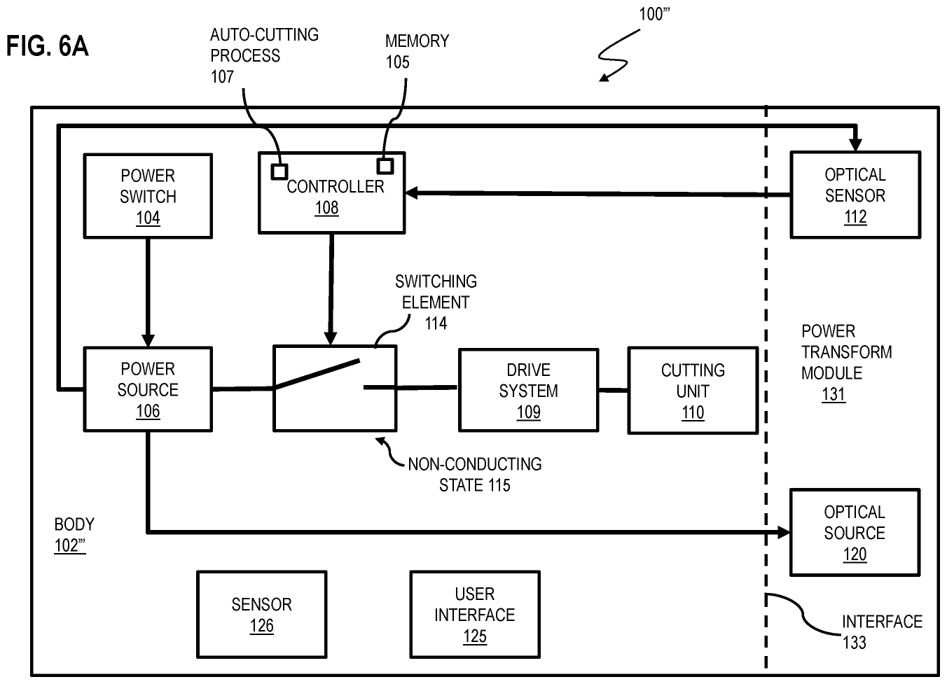

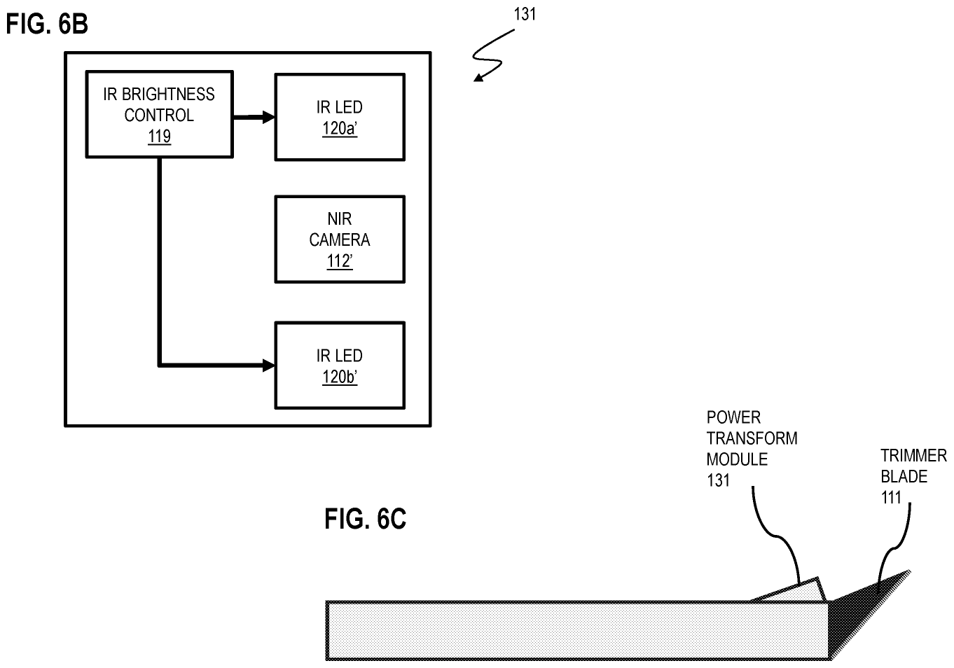

Although the embodiments of the hair cutting appliance depicted in FIGS. 3A through 3E illustrate that the optical sensor 112′ and the optical source 120′ are housed within the body 102′, in other embodiments a body 102′″ is provided which does not house the optical sensor and the optical source. In these embodiments, the optical sensor and optical source are enclosed within a power transform module that is removably attached to the body 102′″. FIGS. 6A through 6C is an example according to various embodiments illustrating a power transform module 131 used with a hair cutting appliance 100′″. As shown in FIG. 6A, the power transform module 131 houses the optical sensor 112 (e.g., NIR camera 112′, as shown in FIG. 6B) and the one or more optical sources 120 (e.g., pair of IR LEDs 120a′, 120b′, as shown in FIG. 6B). FIG. 6B depicts one example embodiment of the power transform module 131 where the optical sensor 112 is the NIR camera 112′ and the one or more optical sources 120 are a pair of IR LEDs 120a′, 120b′ that is similar to the embodiment of FIGS. 3A through 3E.

In an embodiment, the power transform module 131 is for use with a hair cutting appliance 100′″. The hair cutting appliance 100′″ includes one or more features that are similar to the features of the previously discussed hair cutting appliance 100′, with the exception of the features discussed herein. In one embodiment, the hair cutting appliance 100′″ features a body 102′″ that is similar to the body 102, 102′ but does not house the optical sensor 112 and optical source(s) 120. In one example embodiment, the body 102′″ is a stereolithography (SLA) body. The hair cutting appliance 100′″ also features the power source 106 (e.g., battery) and the drive system 109 (e.g. motor). The hair cutting appliance 100′″ also features the controller 108. In one example embodiment, the controller 108 of the hair cutting appliance 100′″ includes a motor control printed circuit board (PCB). In an example embodiment, the optical sensor 112 of the power transform module 131 is a detector OV5647 and the optical source 120 is one of lumileds Z or C series. FIG. 6A depicts a dotted line indicating the attachment interface 133 between the power transform module 131 and the body 102′″. In an example embodiment, the interface 133 could be comprised of two components (e.g., power source and the data bus). In this example embodiment, the data bus transmits data from the power transform module 131 to the controller 108 for further analysis of optical sensor data. FIG. 6C similarly depicts the power transform module 131 after being mounted to the body 102″.

Upon mounting the power transform module 131 to the body 102″, the NIR camera 112′ and the pair of IR LEDs 120′ are aligned in a similar manner as in the hair cutting appliance 100′ of FIGS. 3A through 3E. Upon mounting the power transform module 131 to the body 102″, the NIR camera 112′ and the pair of IR LEDs 120′ are in communication with the power source 106 and the NIR camera 112′ is in electrical communication with the controller 108. Additionally, upon mounting the power transform module 131 to the body 102′″, the pair of IR LEDs 120′ are configured to project the IR signal 121a, 121b at the area 14 in front of the trimmer blade 111. Additionally, upon mounting the power transform module 131 to the body 102″, the NIR camera 112′ is configured to sense the pre-defined skin-hair edge 16 in the area in front of the trimmer blade 111. As shown in FIG. 6A, the hair cutting appliance 100′″ features the switching element 114 that acts in a similar manner as the switching element 114 of FIGS. 2A and 2B of the hair cutting appliance 100. The controller 108 of FIG. 6A acts in a similar manner as the controller 108 of FIGS. 2A and 2B in terms of switching the switching element 114 between the non-conducting state 115 (to not cut hair in the area 14) and the conducting state 117 (to cut hair in the area) depending on the image data received from the NIR camera 112′ of the area 14 in front of the trimmer blade 111.

### Method for Assembling a Hair Cutting Appliance

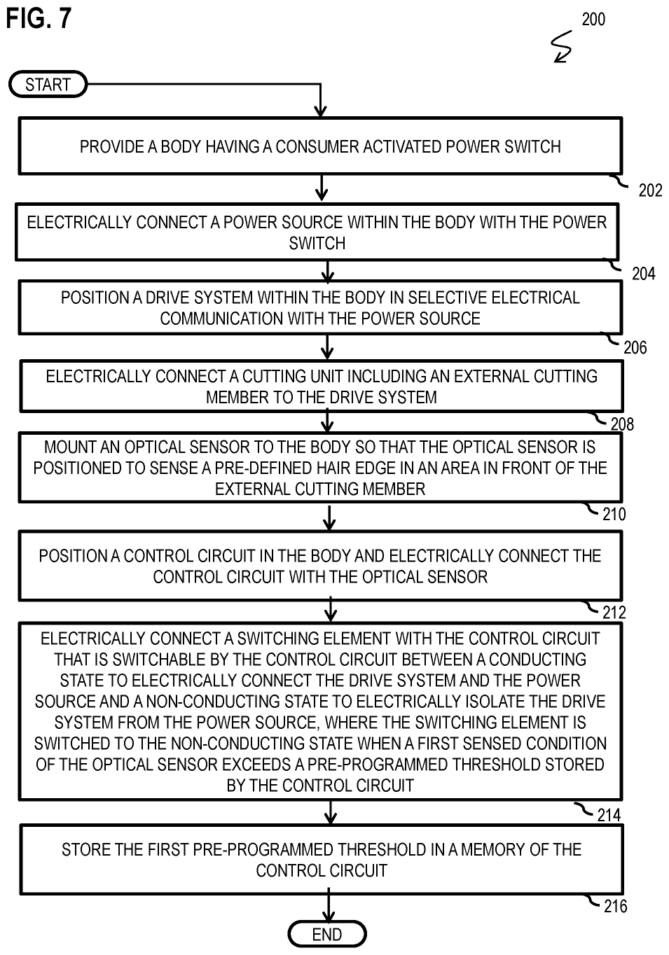

A method for assembling the hair cutting appliance will now be discussed. FIG. 7 is an example according to various embodiments illustrating a flowchart that depicts a method 200 for assembling a hair cutting appliance. Although steps are depicted in FIG. 7 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 202, the body of the hair cutting appliance is provided with a consumer activated power switch. In one embodiment, in step 202 the body 102, 102′, 102″, 102′″ is provided with the consumer activated power switch 104, 104′.

In step 204, a power source within the body is electrically connected with the power switch. In one embodiment, in step 204 the power source 106, 106′ within the body 102, 102′, 102″, 102′″ is electrically connected with the power switch 104, 104′.

In step 206, a drive system is positioned within the body and in selective electrical communication with the power source. In one embodiment, the drive system 109, 109′ is positioned within the body 102, 102′, 102″, 102′″ and in selective electrical communication with the power source 106, 106′.

In step 208, the cutting unit of the hair cutting appliance is electrically connected with the drive system. In one embodiment, in step 208 the trimmer blade 111 is electrically connected with the drive system 109, 109′.

In step 210, the optical sensor is mounted to the body of the hair cutting appliance so that the optical sensor is positioned to sense the pre-defined hair-skin edge in an area in front of the external cutting member of the cutting unit. In one embodiment, in step 210 the NIR camera 112′ is mounted to the body 102′ of the hair cutting appliance 100′ so that the NIR camera 112′ is positioned to sense the pre-defined skin-hair edge 16 in the area 14 in front of the trimmer blade 111. As shown in FIG. 3B, in step 210 the NIR camera 112′ is mounted within the body 102′ such that the optical axis 142 of the NIR camera 112′ is oriented at the angle 144 relative to the normal 140 to the cutting plane 141. In another embodiment, as shown in FIG. 4A the NIR camera 112′ is mounted to the body 102″ of the hair cutting appliance 100″ so that the optical axis of the NIR camera 112′ (not shown in FIG. 4A) is similarly aligned relative to the cutting plane 141 as shown in FIG. 3B. In yet another embodiment, as shown in FIGS. 6A through 6C, in step 210 the NIR camera 112′ is mounted to the body 102′″ based on mounting the power transform module 131 (that houses the NIR camera 112′) to the body 102′″. In this embodiment, upon mounting the power transform module 131 to the body 102′″ the NIR camera 112′ is oriented in a similar manner as FIG. 3B with respect to the cutting plane 141.

In another embodiment, in step 210 the optical source is mounted to the body of the hair cutting appliance so that the optical signal from the optical source is directed to illuminate the area in front of the external cutting member of the cutting unit and thus facilitate the optical sensor capturing image data of the area. In one embodiment, as shown in FIG. 3C in step 210 the IR LEDs 120a′, 120b′ are mounted to the body 102′ of the hair cutting appliance 100′ so that the IR signals 121a, 121b illuminate the area 14 in front of the trimer blade 111. In another embodiment, as shown in FIG. 4A the IR LEDs 120′ are mounted to the body 102″ of the hair cutting appliance 100″ so that the IR signals 121a, 121b (not shown in FIG. 4A) illuminate the area 14 in front of the trimmer blade 111 in a similar manner as the IR LEDs 120′ of FIG. 3C. In yet another embodiment, as shown in FIGS. 6A through 6C, in step 210 the IR LEDs 120a′, 120b′ are mounted to the body 102′″ based on mounting the power transform module 131 (that houses the IR LEDS 120′) to the body 102′″. In this embodiment, upon mounting the power transform module 131 to the body 102′″ the IR LEDs 120a′, 120b′ are oriented in a similar manner as FIG. 3B to similarly illuminate the area 14 in front of the trimmer blade 111.

In step 212, a control circuit or controller is positioned within the body of the hair cutting appliance and electrically connected with the optical sensor. In one embodiment, in step 212 the controller 108 positioned within the body 102, 102′, 102″ is electrically connected with the NIR camera 112′. In another embodiment, in step 212 the controller 108 within the body 102′″ of FIG. 6A is electrically connected with the NIR camera 112′ of the power transform module 131, upon mounting the power transform module 131 to the body 102″ “.

In step 214, a switching element is electrically connected with the control circuit or controller within the body. In one embodiment, the switching element 114 within the body 102, 102′, 102” is electrically connected with the controller 108.

In an embodiment, in step 214 upon electrically connecting the switching element 114 with the controller 108, the switching element 114 is switchable by the controller 108 between the conducting state 117 (FIG. 2B) and the non-conducting state 115 (FIG. 2A).

In step 216 the first pre-programmed threshold is stored in a memory of the control circuit or controller. In an embodiment, in step 216 the first pre-programmed threshold is stored in the memory 105 of the controller 108. In one embodiment, step 216 is performed during a calibration mode of the hair cutting appliance, as previously discussed herein. In another embodiment, in step 216 a user manually inputs a value of the first pre-programmed threshold using an input device (e.g. input device 312). In yet another embodiment, in step 216 the manufacturer of the hair cutting appliance stores the value of the first pre-programmed threshold in the memory 105.

### Hardware

FIG. 8 is a block diagram that illustrates a computer system 300 upon which an embodiment of the invention may be implemented. Computer system 300 includes a communication mechanism such as a bus 310 for passing information between other internal and external components of the computer system 300. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 300, or a portion thereof, constitutes a means for performing one or more steps of one or more methods described herein.

A sequence of binary digits constitutes digital data that is used to represent a number or code for a character. A bus 310 includes many parallel conductors of information so that information is transferred quickly among devices coupled to the bus 310. One or more processors 302 for processing information are coupled with the bus 310. A processor 302 performs a set of operations on information. The set of operations include bringing information in from the bus 310 and placing information on the bus 310. The set of operations also typically include comparing two or more units of information, shifting positions of units of information, and combining two or more units of information, such as by addition or multiplication. A sequence of operations to be executed by the processor 302 constitutes computer instructions.

Computer system 300 also includes a memory 304 coupled to bus 310. The memory 304, such as a random access memory (RAM) or other dynamic storage device, stores information including computer instructions. Dynamic memory allows information stored therein to be changed by the computer system 300. RAM allows a unit of information stored at a location called a memory address to be stored and retrieved independently of information at neighboring addresses. The memory 304 is also used by the processor 302 to store temporary values during execution of computer instructions. The computer system 300 also includes a read only memory (ROM) 306 or other static storage device coupled to the bus 310 for storing static information, including instructions, that is not changed by the computer system 300. Also coupled to bus 310 is a non-volatile (persistent) storage device 308, such as a magnetic disk or optical disk, for storing information, including instructions, that persists even when the computer system 300 is turned off or otherwise loses power.

Information, including instructions, is provided to the bus 310 for use by the processor from an external input device 312, such as a keyboard containing alphanumeric keys operated by a human user, or a sensor. A sensor detects conditions in its vicinity and transforms those detections into signals compatible with the signals used to represent information in computer system 300. Other external devices coupled to bus 310, used primarily for interacting with humans, include a display device 314, such as a cathode ray tube (CRT) or a liquid crystal display (LCD), for presenting images, and a pointing device 316, such as a mouse or a trackball or cursor direction keys, for controlling a position of a small cursor image presented on the display 314 and issuing commands associated with graphical elements presented on the display 314.

In the illustrated embodiment, special purpose hardware, such as an application specific integrated circuit (IC) 320, is coupled to bus 310. The special purpose hardware is configured to perform operations not performed by processor 302 quickly enough for special purposes. Examples of application specific ICs include graphics accelerator cards for generating images for display 314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 300 also includes one or more instances of a communications interface 370 coupled to bus 310. Communication interface 370 provides a two-way communication coupling to a variety of external devices that operate with their own processors, such as printers, scanners and external disks. In general the coupling is with a network link 378 that is connected to a local network 380 to which a variety of external devices with their own processors are connected. For example, communication interface 370 may be a parallel port or a serial port or a universal serial bus (USB) port on a personal computer. In some embodiments, communications interface 370 is an integrated services digital network (ISDN) card or a digital subscriber line (DSL) card or a telephone modem that provides an information communication connection to a corresponding type of telephone line. In some embodiments, a communication interface 370 is a cable modem that converts signals on bus 310 into signals for a communication connection over a coaxial cable or into optical signals for a communication connection over a fiber optic cable. As another example, communications interface 370 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 370 sends and receives electrical, acoustic or electromagnetic signals, including infrared and optical signals, that carry information streams, such as digital data.

The term computer-readable medium is used herein to refer to any medium that participates in providing information to processor 302, including instructions for execution. Such a medium may take many forms, including, but not limited to, non-volatile media, volatile media and transmission media. Non-volatile media include, for example, optical or magnetic disks, such as storage device 308. Volatile media include, for example, dynamic memory 304. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 302, except for carrier waves and other signals.

Logic encoded in one or more tangible media includes one or both of processor instructions on a computer-readable storage media and special purpose hardware, such as ASIC *320.

Network link 378 typically provides information communication through one or more networks to other devices that use or process the information. For example, network link 378 may provide a connection through local network 380 to a host computer 382 or to equipment 384 operated by an Internet Service Provider (ISP). ISP equipment 384 in turn provides data communication services through the public, world-wide packet-switching communication network of networks now commonly referred to as the Internet 390. A computer called a server 392 connected to the Internet provides a service in response to information received over the Internet. For example, server 392 provides information representing video data for presentation at display 314.

The invention is related to the use of computer system 300 for implementing the techniques described herein. According to one embodiment of the invention, those techniques are performed by computer system 300 in response to processor 302 executing one or more sequences of one or more instructions contained in memory 304. Such instructions, also called software and program code, may be read into memory 304 from another computer-readable medium such as storage device 308. Execution of the sequences of instructions contained in memory 304 causes processor 302 to perform the method steps described herein. In alternative embodiments, hardware, such as application specific integrated circuit 320, may be used in place of or in combination with software to implement the invention. Thus, embodiments of the invention are not limited to any specific combination of hardware and software.

The signals transmitted over network link 378 and other networks through communications interface 370, carry information to and from computer system 300. Computer system 300 can send and receive information, including program code, through the networks 380, 390 among others, through network link 378 and communications interface 370. In an example using the Internet 390, a server 392 transmits program code for a particular application, requested by a message sent from computer 300, through Internet 390, ISP equipment 384, local network 380 and communications interface 370. The received code may be executed by processor 302 as it is received, or may be stored in storage device 308 or other non-volatile storage for later execution, or both. In this manner, computer system 300 may obtain application program code in the form of a signal on a carrier wave.

Various forms of computer readable media may be involved in carrying one or more sequence of instructions or data or both to processor 302 for execution. For example, instructions and data may initially be carried on a magnetic disk of a remote computer such as host 382. The remote computer loads the instructions and data into its dynamic memory and sends the instructions and data over a telephone line using a modem. A modem local to the computer system 300 receives the instructions and data on a telephone line and uses an infra-red transmitter to convert the instructions and data to a signal on an infra-red a carrier wave serving as the network link 378. An infrared detector serving as communications interface 370 receives the instructions and data carried in the infrared signal and places information representing the instructions and data onto bus 310. Bus 310 carries the information to memory 304 from which processor 302 retrieves and executes the instructions using some of the data sent with the instructions. The instructions and data received in memory 304 may optionally be stored on storage device 308, either before or after execution by the processor 302.

FIG. 9 illustrates a chip set 400 upon which an embodiment of the invention may be implemented. Chip set 400 is programmed to perform one or more steps of a method described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 400, or a portion thereof, constitutes a means for performing one or more steps of a method described herein.

In one embodiment, the chip set 400 includes a communication mechanism such as a bus 401 for passing information among the components of the chip set 400. A processor 403 has connectivity to the bus 401 to execute instructions and process information stored in, for example, a memory 405. The processor 403 may include one or more processing cores with each core configured to perform independently. A multi-core processor enables multiprocessing within a single physical package. Examples of a multi-core processor include two, four, eight, or greater numbers of processing cores. Alternatively or in addition, the processor 403 may include one or more microprocessors configured in tandem via the bus 401 to enable independent execution of instructions, pipelining, and multithreading. The processor 403 may also be accompanied with one or more specialized components to perform certain processing functions and tasks such as one or more digital signal processors (DSP) 407, or one or more application-specific integrated circuits (ASIC) 409. A DSP 407 typically is configured to process real-world signals (e.g., sound) in real time independently of the processor 403. Similarly, an ASIC 409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 403 and accompanying components have connectivity to the memory 405 via the bus 401. The memory 405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 405 also stores the data associated with or generated by the execution of one or more steps of the methods described herein.

### Combinations

Various embodiments relate to:
1. A hair cutting appliance that includes a body having a consumer actuated power switch and a power source in electrical communication with the power switch. The hair cutting appliance also includes a drive system positioned within the body in selective electrical communication with the power source. The hair cutting appliance also includes a cutting unit coupled to the drive system and comprising an external cutting member. The hair cutting appliance also includes an optical sensor mounted to the body and positioned to sense a pre-defined skin-hair edge in an area in front of the external cutting member. The hair cutting appliance also includes a control circuit positioned within the body and in electrical communication with the at least one optical sensor. The hair cutting appliance also includes a switching element in electrical communication with the control circuit. The switching element is switchable by the control circuit between a conducting state to electrically connect the drive system and the power source and a non-conducting state to electrically isolate the drive system from the power source. The switching element is switched by the control circuit to the non-conducting state when a first sensed condition of the at least one optical sensor exceeds a first pre-programed threshold stored by the control circuit.
2. The hair cutting appliance according to paragraph 1, where the switching element is switched by the control unit to the conducting state when a second sensed condition of the at least one optical sensor is equal to or less than the first pre-programed threshold stored by the control circuit.
3. The hair cutting appliance according to either paragraph 1 or 2, further comprising a light source mounted to the body, the light source projecting a light signal at the area in front of the external cutting member.
4. The hair cutting appliance of paragraph 3, where a wavelength of the light source is in a range from about 400 nm to about 1000 nm.
5. The hair cutting appliance of any of paragraphs 1 to 4, further comprising a user interface on the body indicating a status of the switching element.
6. The hair cutting appliance of any of paragraphs 1 to 5, where the control circuit sends a signal to a user interface on the body indicating a stroke speed.
7. The hair cutting appliance of any of paragraphs 1 to 6, where the control circuit comprises a timer.
8. The hair cutting appliance of any of paragraphs 1 to 7, where the first pre-programed threshold comprises one or more of hair length, hair density, hair color, individual hair thickness and hair straightness.
9. The hair cutting appliance of any of paragraphs 1 to 8, where the first pre-programed threshold includes a hair length in a range from about 0.3 mm to about 3.5 mm.
10. The hair cutting appliance of any of paragraphs 1 to 9, where the control circuit is configured to receive a signal from the timer indicating an elapsed time since a most recent use of the hair cutting appliance and where the control circuit is configured to switch the switching element to the conducting state when the elapsed time is less than a second pre-programmed threshold stored by the control circuit.
11. The hair cutting appliance of any of paragraphs 1 to 10, where the consumer actuated power switch comprises one of a push button actuator, a motion sensor or a touch sensor.
12. The hair cutting appliance of any of paragraphs 1 to 11, where the external cutting member comprises one of reciprocating blades, rotating blades or linear blades.
13. The hair cutting appliance of any of paragraphs 1 to 12, where the control circuit is a microcontroller including a processor and a memory with the stored first pre-programmed threshold and a stored set of instructions such that when executed by the processor, causes the appliance to perform the following steps: receive, at the control circuit, first image data from the at least one optical sensor of a first area in front of the external cutting member; determine, with the control circuit, the first sensed condition including a value of a parameter of hair in the first area based on the first image data; determine, with the control circuit, that the first sensed condition including the value of the parameter of hair exceeds the first pre-programmed threshold stored in the memory; and transmit, with the control circuit, a first signal to the switching element to cause the switching element to switch to the non-conducting state.
14. The hair cutting appliance of any of paragraphs 1 to 13, where the stored set of instructions are such that when executed by the processor, causes the appliance to further perform the following steps: receive, at the control circuit, second image data from the at least one optical sensor of a second area in front of the external cutting member; determine, with the control circuit, a second sensed condition including a value of a parameter of hair in the second area based on the second image data; determine, with the control circuit, that the second sensed condition including the value of the parameter is equal to or less than the first pre-programmed threshold stored in the memory; and transmit, with the control circuit, a second signal to the switching element to cause the switching element to switch to the conducting state.
15. The hair cutting appliance of any of paragraphs 1 to 14, further comprising a user interface on the body in communication with the control circuit and wherein upon the control circuit receiving a first signal from the timer indicating that an elapsed time since a most recent use of the hair cutting appliance, the control circuit is configured to transmit a second signal to the user interface to output on the user interface one or more of the elapsed time and a time frequency of use of the hair cutting appliance over a predetermined time period.
16. The hair cutting appliance of any of paragraphs 1 to 15, where the at least one optical sensor is mounted to the body such that an optical axis of the at least one optical sensor is oriented at an angle relative to a normal direction to a cutting plane defined by the at least one cutting unit.
17. The hair cutting appliance of any of paragraphs 1 to 16, where the angle is in a range between about 0 degrees and about 60 degrees.
18. The hair cutting appliance of any of paragraphs 1 to 17, where the first pre-programmed threshold is based on an average growth rate of human hair and a predetermined amount of time.
19. A power transform module for use with a hair cutting appliance, the hair cutting appliance comprising a body having a consumer actuated power switch, a power source in electrical communication with the power switch, a drive system positioned within the body in selective electrical communication with the power source, at least one cutting unit coupled to the drive system and comprising an external cutting member, a control circuit positioned within the body, a switching element in electrical communication with the control circuit, the switching element switchable by the control circuit between a conducting state to electrically connect the drive system and the power source and a non-conducting state to electrically isolate the drive system from the power source. The power transform module includes: at least one optical sensor; at least one optical source, where the power transform module is configured to be mounted to the body such that upon mounting the power transform module to the body; where the at least one optical sensor and the at least one optical source are in communication with the power source; where the at least one optical sensor is in electrical communication with the control circuit; where the at least one optical source is configured to project an optical signal at an area in front of the external cutting member; where the at least one optical sensor is configured to sense a pre-defined skin-hair edge in the area in front of the external cutting member; and where the switching element is configured to be switched by the control circuit to the non-conducting state when a first sensed condition of the at least one optical sensor exceeds a first-preprogrammed threshold stored by the control circuit.
20. The power transform module of paragraph 19, where upon mounting the power transform module to the body: an optical axis of the at least one optical sensor is oriented at an angle relative to a normal direction to a cutting plane defined by the at least one cutting unit and where the angle is in a range between about 0 degrees and about 60 degrees.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A hair cutting appliance comprising:
a body having a consumer actuated power switch;
a power source in electrical communication with the power switch;
a drive system positioned within the body in selective electrical communication with the power source;
at least one cutting unit coupled to the drive system and comprising an external cutting member;
at least one optical sensor mounted to the body and positioned to sense a pre-defined skin-hair edge in an area in front of the external cutting member;
a control circuit positioned within the body and in electrical communication with the at least one optical sensor; and
a switching element in electrical communication with the control circuit, the switching element switchable by the control circuit between a conducting state to electrically connect the drive system and the power source and a non-conducting state to electrically isolate the drive system from the power source, wherein the switching element is switched by the control circuit to the non-conducting state when a first sensed condition of the at least one optical sensor exceeds a first pre-programed threshold stored by the control circuit.

2. The hair cutting appliance of claim 1 wherein the switching element is switched by the control unit to the conducting state when a second sensed condition of the at least one optical sensor is equal to or less than the first pre-programed threshold stored by the control circuit.

3. The hair cutting appliance of claim 1 further comprising a light source mounted to the body, the light source projecting a light signal at the area in front of the external cutting member.

4. The hair cutting appliance of claim 3 wherein a wavelength of the light source is in a range from about 400 nm to about 1000 nm.

5. The hair cutting appliance of claim 1 further comprising a user interface on the body indicating a status of the switching element.

6. The hair cutting appliance of claim 1 wherein the control circuit sends a signal to a user interface on the body indicating a stroke speed.

7. The hair cutting appliance of claim 1 wherein the control circuit comprises a timer.

8. The hair cutting appliance of claim 1 wherein first pre-programed threshold comprises one or more of hair length, hair density, hair color, individual hair thickness and hair straightness.

9. The hair cutting appliance of claim 1 wherein the first pre-programed threshold includes a hair length in a range from about 0.3 mm to about 3.5 mm.

10. The hair cutting appliance of claim 7, wherein the control circuit is configured to receive a signal from the timer indicating an elapsed time since a most recent use of the hair cutting appliance and wherein the control circuit is configured to switch the switching element to the conducting state when the elapsed time is less than a second pre-programmed threshold stored by the control circuit.

11. The hair cutting appliance of claim 1, wherein the consumer actuated power switch comprises one of a push button actuator, a motion sensor or a touch sensor.

12. The hair cutting appliance of claim 1, wherein the external cutting member comprises one of reciprocating blades, rotating blades or linear blades.

13. The hair cutting appliance of claim 1, wherein the control circuit is a microcontroller including a processor and a memory with the stored first pre-programmed threshold and a stored set of instructions such that when executed by the processor, causes the appliance to perform the following steps:
receive, at the control circuit, first image data from the at least one optical sensor of a first area in front of the external cutting member;
determine, with the control circuit, the first sensed condition including a value of a parameter of hair in the first area based on the first image data;
determine, with the control circuit, that the first sensed condition including the value of the parameter of hair exceeds the first pre-programmed threshold stored in the memory; and
transmit, with the control circuit, a first signal to the switching element to cause the switching element to switch to the non-conducting state.

14. The hair cutting appliance of claim 13, wherein the stored set of instructions are such that when executed by the processor, causes the appliance to further perform the following steps:
receive, at the control circuit, second image data from the at least one optical sensor of a second area in front of the external cutting member;
determine, with the control circuit, a second sensed condition including a value of a parameter of hair in the second area based on the second image data;
determine, with the control circuit, that the second sensed condition including the value of the parameter is equal to or less than the first pre-programmed threshold stored in the memory; and
transmit, with the control circuit, a second signal to the switching element to cause the switching element to switch to the conducting state.

15. The hair cutting appliance of claim 7, further comprising a user interface on the body in communication with the control circuit and wherein upon the control circuit receiving a first signal from the timer indicating that an elapsed time since a most recent use of the hair cutting appliance, the control circuit is configured to transmit a second signal to the user interface to output on the user interface one or more of the elapsed time and a time frequency of use of the hair cutting appliance over a predetermined time period.

16. The hair cutting appliance of claim 1, wherein the at least one optical sensor is mounted to the body such that an optical axis of the at least one optical sensor is oriented at an angle relative to a normal direction to a cutting plane defined by the at least one cutting unit.

17. The hair cutting appliance of claim 16, wherein the angle is in a range between about 0 degrees and about 60 degrees.

18. The hair cutting appliance of claim 1, wherein the first pre-programmed threshold is based on an average growth rate of human hair and a predetermined amount of time.

19. A power transform module for use with a hair cutting appliance, the hair cutting appliance comprising a body having a consumer actuated power switch, a power source in electrical communication with the power switch, a drive system positioned within the body in selective electrical communication with the power source, at least one cutting unit coupled to the drive system and comprising an external cutting member, a control circuit positioned within the body, a switching element in electrical communication with the control circuit, the switching element switchable by the control circuit between a conducting state to electrically connect the drive system and the power source and a non-conducting state to electrically isolate the drive system from the power source, the power transform module comprising:
at least one optical sensor;
at least one optical source;
wherein the power transform module is configured to be mounted to the body such that upon mounting the power transform module to the body;
the at least one optical sensor and the at least one optical source are in communication with the power source;
the at least one optical sensor is in electrical communication with the control circuit;
the at least one optical source is configured to project an optical signal at an area in front of the external cutting member;
the at least one optical sensor is configured to sense a pre-defined skin-hair edge in the area in front of the external cutting member;
and wherein the switching element is configured to be switched by the control circuit to the non-conducting state when a first sensed condition of the at least one optical sensor exceeds a first-preprogrammed threshold stored by the control circuit.

20. The power transform module of claim 19, wherein upon mounting the power transform module to the body:
an optical axis of the at least one optical sensor is oriented at an angle relative to a normal direction to a cutting plane defined by the at least one cutting unit;
wherein the angle is in a range between about 0 degrees and about 60 degrees.
